(19) United States
(12) Patent Application Publication
(10) Pub. No.: US 2019/0197986 A1
(43) Pub. Date: Jun. 27, 2019

(54) METHODS FOR DYNAMICALLY PROVIDING AN IMAGE TO BE DISPLAYED

(71) Applicant: Mastercard International Incorporated, Purchase, NY (US)

(72) Inventors: Rajesh Pralhadrao Mahalle, Pune (IN); Ankit Kumar Binnani, Pune (IN)

(73) Assignee: Mastercard International Incorporated, Purchase, NY (US)

(21) Appl. No.: 16/152,701

(22) Filed: Oct. 5, 2018

(30) Foreign Application Priority Data
Dec. 22, 2017 (SG) 10201710762U

(51) Int. Cl. G09G 5/00; G06T 3/40

(52) U.S. Cl. CPC G09G 5/005; G09G 2340/045; G06T 3/40

(57) ABSTRACT

According to an embodiment, there is provided a method for dynamically providing an image to be displayed on a display of a device. The method includes: receiving a source image; receiving a property of the display of the device on which the image is to be displayed; determining a processing rule based on the source image; processing the source image based on the processing rule and based on the property of the display of the device to obtain the image to be displayed; and providing the image to be displayed to the device

### CROSS REFERENCE TO RELATED APPLICATIONS

This application claims priority to Singaporean Application Serial No. 10201710762U, filed Dec. 22, 2017, which is incorporated herein by reference in its entirety

### FIELD OF INVENTION

The present invention relates broadly, but not exclusively, to methods for dynamically providing an image to be displayed on a display of a device, and to image providing devices (for example image providing servers), for example to provide a meaningful image even if the image is modified to fit different output devices.

### BACKGROUND

In today's world, media plays an important role in engaging and providing rich user experience to consumers. Today consumers access digital properties (for example) using multiple channels or devices. Each device has unique characteristics and consumers expect seamless user experience across devices. However, providing all this data may be cumbersome.

For example, creating multiple renditions of an image, i.e. multiple copies of the image, which may have different dimensions for different devices may require storing multiple images copied in a digital asset manager and may un-necessarily increase the size of the repository and associated cost to maintain the same. This may also cause issues while searching an image where there will be multiple results of the same image.

FIGS. 2 to 6 show examples 200, 300, 400, 500, and 600 of how in priceless.com different copies of the same image are stored.

Digital companies may be using image rendition tools which work on common sets of presentment rules to show images on different devices like mobile phones, tablets, desktops etc. These presentment rules may be common for all the images and cannot be personalized according to the type of image. In the example shown above, few images may have subjects either half cropped or totally cropped which does not serve the purpose of a seamless and rich digital experience.

FIGS. 7 and 8 show screenshots 700 and 800 of an example which provides the information related to the existing issues which are there on the various digital websites because a common presentment rule is used for all the images, and the image 700 of FIG. 7 is of a desktop view point and image 800 of FIG. 8 is of a mobile landscape view. It may be seen in the mobile image 800 that the head of the lady cannot be seen.

Some digital properties use a responsive image styling and apply this on the source image, but the same image is scaled down or scaled up based on a device's breakpoint, but users cannot see on a smaller device a specific area which the marketer may want to be highlighted. The additional problem is that on devices where a high resolution image is loaded and the original image is downloaded, excessive network bandwidth is consumed (regardless of whether the high resolution image is actually displayed in high resolution).

A need therefore exists to provide devices and methods to address the above problems.

### SUMMARY

According to a first aspect, there is provided a method for dynamically providing an image to be displayed on a display of a device. The method includes: receiving a source image; receiving a property of the display of the device on which the image is to be displayed; determining a processing rule based on the source image; processing the source image based on the processing rule and based on the property of the display of the device to obtain the image to be displayed; and providing the image to be displayed to the device.

According to a second aspect, there is provided an image providing device. The image providing device includes: at least one processor; and at least one memory including computer program code. The at least one memory and the computer program code are configured to, with the at least one processor, cause the at least one processor to: receive a source image; receive a property of a display of a target device on which the image is to be displayed; determine a processing rule based on the source image; process the source image based on the processing rule and based on the property of the display of the target device to obtain the image to be displayed; and provide the image to be displayed to the target device.

According to a third aspect, there is provided a method for dynamically displaying a cropped image. The method includes: receiving an original image; determining a target size of an image to be displayed; determining a cropping rule based on the original image and based on a target size, wherein the cropping rule comprises a starting point of cropping; and cropping the original image to obtain the cropped image to be displayed based on the cropping rule.

### BRIEF DESCRIPTION OF THE DRAWINGS

Embodiments and implementations are provided by way of example only, and will be better understood and readily apparent to one of ordinary skill in the art from the following written description, read in conjunction with the drawings, in which:

FIG. 1A shows an overview of a system in accordance with an embodiment of the present disclosure;

FIG. 1B shows a flow diagram illustrating a method for dynamically providing an image to be displayed on a display of a device in accordance with an embodiment of the present disclosure;

FIGS. 2 to 11 show examples of how different copies of the same image are stored in commonly used systems in accordance with a prior art;

FIG. 12A shows a system diagram illustrating component interaction in accordance with an embodiment of the present disclosure;

FIG. 12B shows a flow diagram illustrating the processing of the UI layer and the image presentment component as shown in FIG. 12A in accordance with an embodiment of the present disclosure;

FIG. 12C shows a flow diagram illustrating an authorizing method in accordance with an embodiment of the present disclosure; and

FIG. 13 depicts an exemplary computing device in accordance with an embodiment of the present disclosure.

### DETAILED DESCRIPTION

### Overview

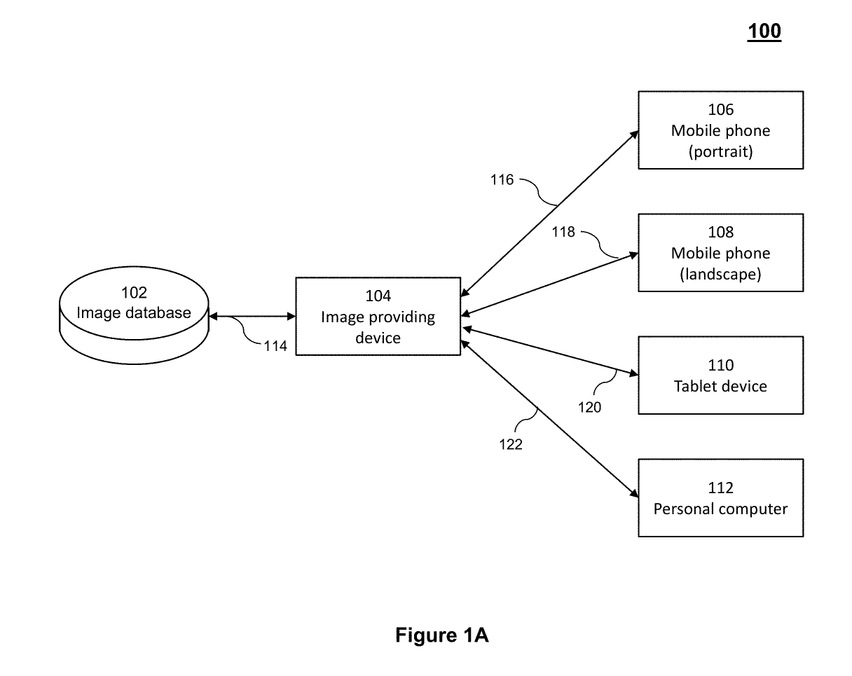

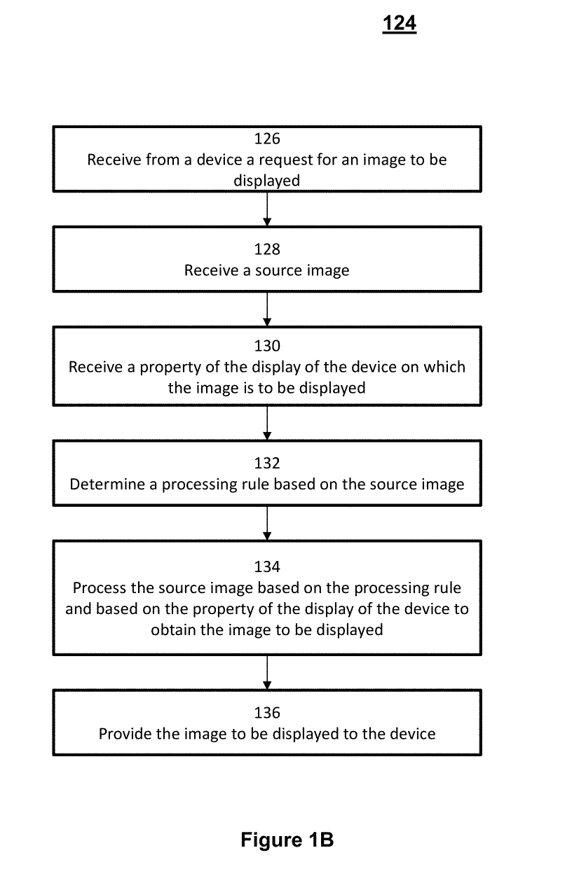

FIG. 1A shows an overview of a system 100 in accordance with an embodiment of the present disclosure. Various devices (like a mobile phone 106 which is in portrait orientation, a mobile phone 108 which is in landscape orientation, a tablet device 110, or a personal computer 112) may be used to view websites and applications which display images. Each of these various devices may have a display, and the displays may vary amongst the various devices, for example in size, resolution, or color tones. Furthermore, even the same device may provide different conditions under which an image is displayed, for example depending on an orientation in which the device is used (for example in portrait orientation like mobile phone 106, or for example in landscape orientation like mobile phone 108), or based on a window size in which an image is to be displayed, for example on the personal computer 112.

The website or application that is displayed on each of the various devices may be identical or similar for each of the various devices, and may as such also have access to the same images. However, if the images are displayed on each of the various devices without modification or with a modification that is identical for each image (for example a simple scaling or cropping of the image to fit the display size of the device on which it is to be displayed), this may not lead to satisfying results, since either important details in the image may be too small or may be cropped.

An image providing device 104 is provided which may access source image data, for example on an image database 102, and advantageously processes the source image before providing the image to be displayed to the device on which it is to be displayed. The image providing device 104 may be a server or may be configured to be coupled to a server. In an alternative embodiment, the image providing device 104 may be the target device (i.e. any one of the mobile phone 106 which is in portrait orientation, the mobile phone 108 which is in landscape orientation, the tablet device 110, or the personal computer 112), and it will be understood that in such an embodiment, the processing of the source image is carried out on the target device itself.

Besides the pure image data of the source image, the image providing device 104 also determines a processing rule based on (or related to) the source image, and also receives a property of the display of the device on which the image is to be displayed. For example, the image providing device 104 may receive a request for an image, and the request may include information on the property of the display of the device. In another example, the image providing device 104 requests information on the property of the display of the device, and may receive the requested information in response. As such, the image providing device 104 advantageously has full information of the source image, a rule for processing of the source image to obtain a target image, and the display on which the target image is to be displayed.

The processing rule is specifically designed for the source image, either manually by an author, or automatically by an automated process (which may for example be carried out on the image providing device 104). For the manual design, the author may visually analyze the source image, and may define which portions are most relevant, and which processing is to be carried out for various sizes in which the source image might be displayed. For the automated design, an image analysis process (for example including image segmentation) may be applied to determine areas of interest in the source image, and the processing rules may then be automatically generated to retain those regions of interest even if the source image is to be displayed at a smaller size. The processing rule may be embedded in information within the metadata of the source image. For example, for a source image where an important detail is provided in the upper left corner of the image, and for which it has been determined (for example via tests on different devices) that this detail becomes too small to be appreciated by a user watching the image when it is displayed at a resolution below a certain threshold, the processing rule may indicate that for resolutions equal to or larger than the certain threshold, a re-sizing (in other words: scaling) of the source image is to be performed for obtaining the target image, while the processing rule may indicate that for resolutions smaller than the certain threshold, a cropping (with a starting point, i.e. upper left corner, of the cropping being near the important detail, is to be performed.

As such, advantageously, the image providing device 104 provides different target images to different devices, like illustrated by arrows 116, 118, 120, and 122, and the target images may be different for the different devices, and may have been obtained from the source image by different processing or even different types of processing (for example scaling and/or cropping).

### Terms Description (in Addition to Plain and Dictionary Meaning of Terms)

An “image” as used herein may be a still image (for example a photo or a drawing or a sketch) or a moving image (for example a movie or video clip, or an animated image, for example an animated GIF).

A “source image” may be an image in a highest available (or highest potentially needed on any one of the displays of various (target) devices) quality, for example a pristine source image, for example an original image. A target device is a device on which an image is to be displayed, for example on a website or in an application or app.

A “target image” may be an image of a size or resolution (for example absolute resolution in pixels, or relative resolution, for example a retina (or double) resolution) that is suitable for being displayed on a display of the (target) device, and that includes the desired details of the image (for example the portions of the image that are considered important to the person viewing that image).

A “processing rule” may include a rule for modifying a source image to obtain an image to be displayed on the display of a device. The image to be displayed on the display of a device may also be referred to as a target image. The processing rule may include resizing (in other words: scaling), cropping, recoloring, or any other kind of image processing. Resizing may refer to changing the size (for example in terms of resolution, i.e. number of pixels) without cutting portions of the image. Cropping may refer to cutting only a selected portion of the source image to obtain the target image. Recoloring may refer to changing a color table associated with the image, or changing color values of one or more pixels of the image. The processing rule may be stored with the source image data, for example in metadata of the source image. It will be understood that although reference is made to “a rule”, this “one rule” may include one rule for each of a plurality of different device breakpoints.

A “device breakpoint” may refer to a boundary of screen width (or screen height) at which the layout should change to adapt to the screen size. In other words, a device breakpoint provides a defined resolution, for which a specific layout (or image size) is desired.

“Authoring” is the process of generating a processing rule, either manually by an author, or automatically by an automated process

### Exemplary Embodiments

Embodiments will be described, by way of example only, with reference to the drawings. Like reference numerals and characters in the drawings refer to like elements or equivalents. It is the intent of present embodiments to present methods and devices for dynamically providing an image to be displayed to a display of a device, wherein the image to be displayed is tailored to the display (for example in terms of which portion of the source image is to be displayed, or in terms of size or color).

FIG. 1B shows a flow diagram 124 illustrating a method for dynamically providing an image to be displayed on a display of a device in accordance with an embodiment of the present disclosure.

In 126, an image providing device (for example image providing device 104 as shown in FIG. 1A) receives, from a (target) device, a request for an image to be displayed on a display of the (target) device. This request may trigger the processing described in the present FIG. 1B.

In 128, in response to the request for an image to be displayed, and furthermore in response to a request from the image providing device 104 to a storage, the image providing device 104 receives a source image from the storage device. The storage device may be coupled to the image providing device 104, or may be internal to the image providing device 104. The source image may be a still image or a moving image.

In 130, a property of the display of the device on which the image is to be displayed is received, for example from the image processing device 104 as shown in FIG. 1A. For example, the image providing device 104 may receive a request for an image, and the request may include information on the property of the display of the device. In another example, the image providing device 104 requests information on the property of the display of the device, and may receive the requested information in response. The property may include a size (in cm or inch, or in numbers of pixels), a resolution, color calibration information or any other information that is related to the configuration of the display.

In 132, a processing rule is determined based on the source image. The processing rule may be determined based on metadata of the source image; this may advantageously be simply storing of the source image and the processing rule, since the processing rule is integrally stored with the source image. In an alternative embodiment, the processing rule may be stored as a separate file associated with the source image. The processing rule may include a rule related to cropping of the source image, and/or a rule related to resizing of the source image, and/or a rule related to recoloring of the source image and/or any other rule related to modification of the source image for being displayed on the display. It will be understood that one or more of the aforementioned rules may be included in the processing rule, and if more than one rule is present, the rules may be defined in subsequent order. For example, a processing rule may define that first a cropping is to be carried out, and that thereafter a recoloring is to be carried out, and thereafter a resizing is to be carried out. This may advantageously keep the computational effort low, for example by first cropping and not applying the subsequent steps of resizing and recoloring to the area of the source image that is deleted by the cropping. The step 132 of determining the processing rule may include determining a starting point for the cropping of the source image.

In 134, the source image is processed based on the processing rule and based on the property of the display of the device to obtain the image to be displayed. Processing the source image may include determining a size for the re-sizing of the source image based on the property of the display of the device and/or determining and applying parameters for the recoloring of the source image based on the property of the display of the device and/or any other modification of the source image in response to the processing rule.

In 136, the image to be displayed is provided to the device.

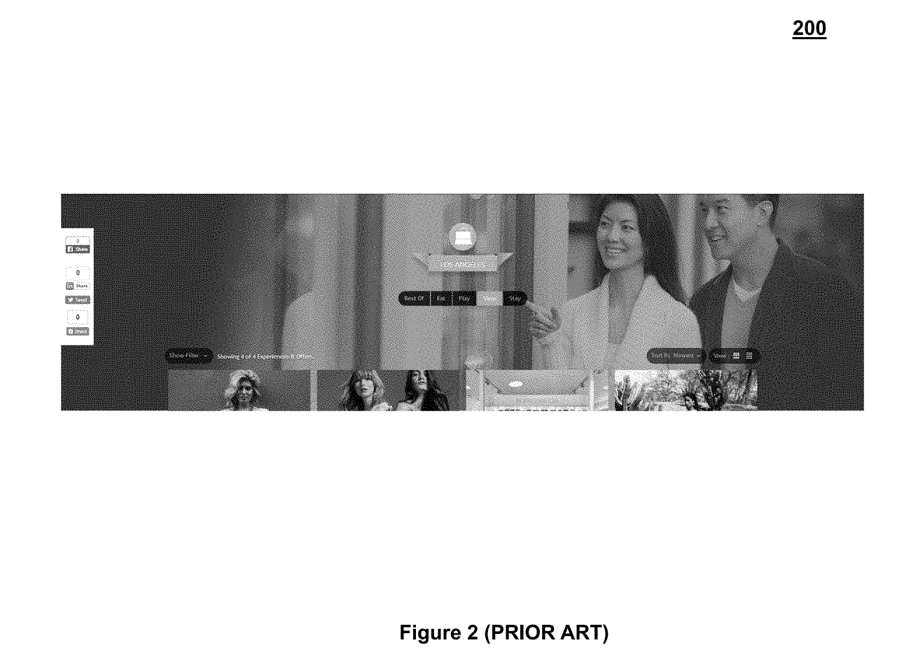

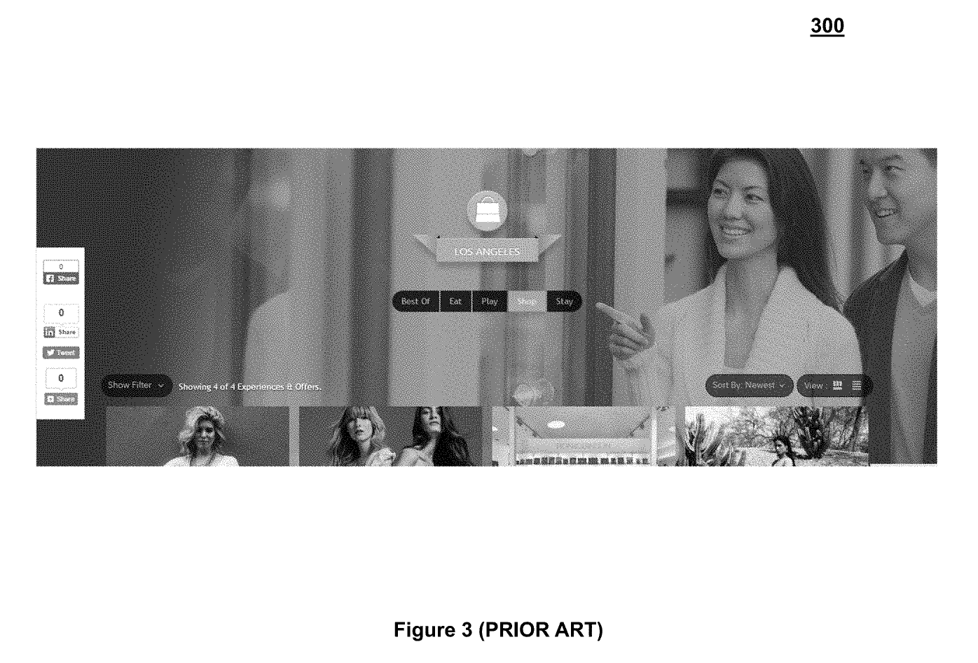

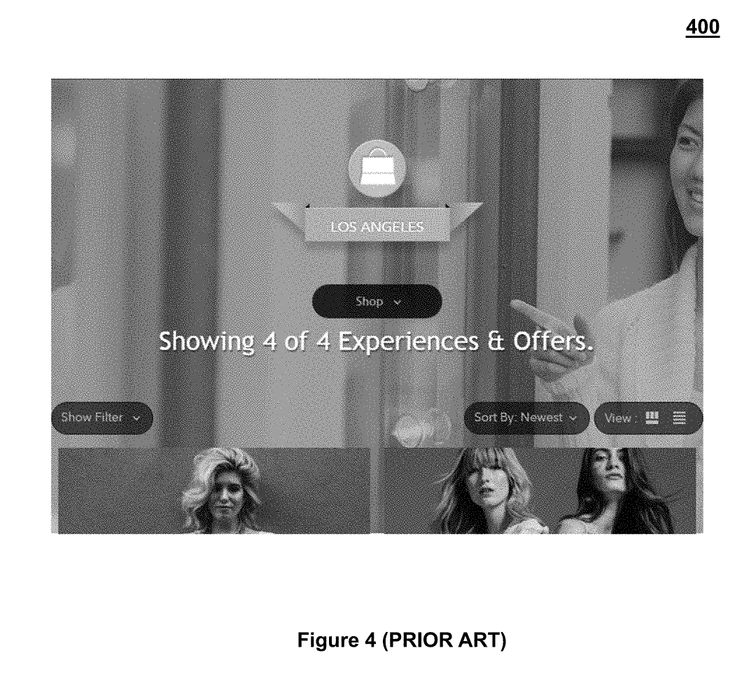

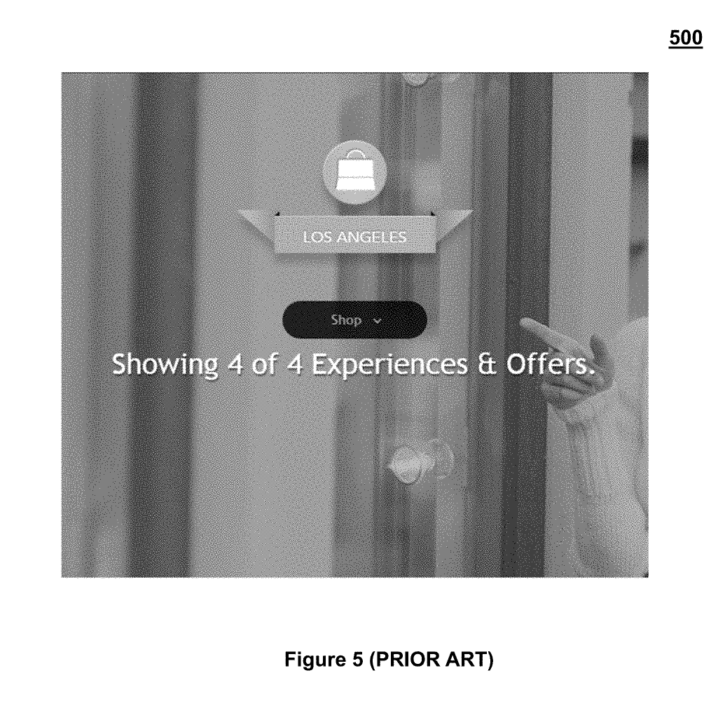

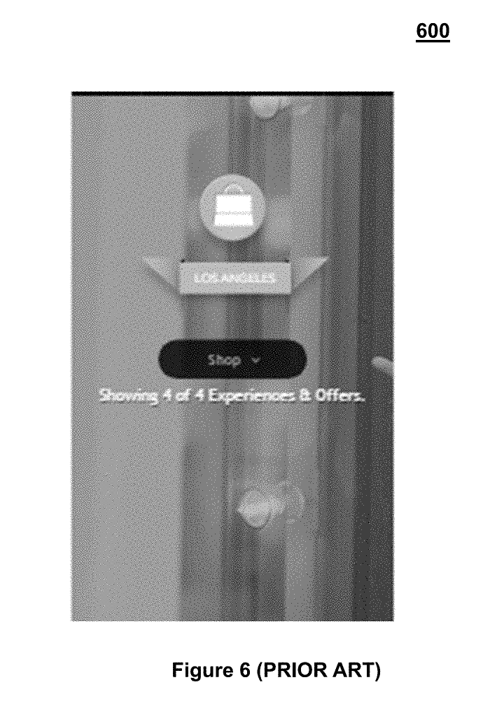

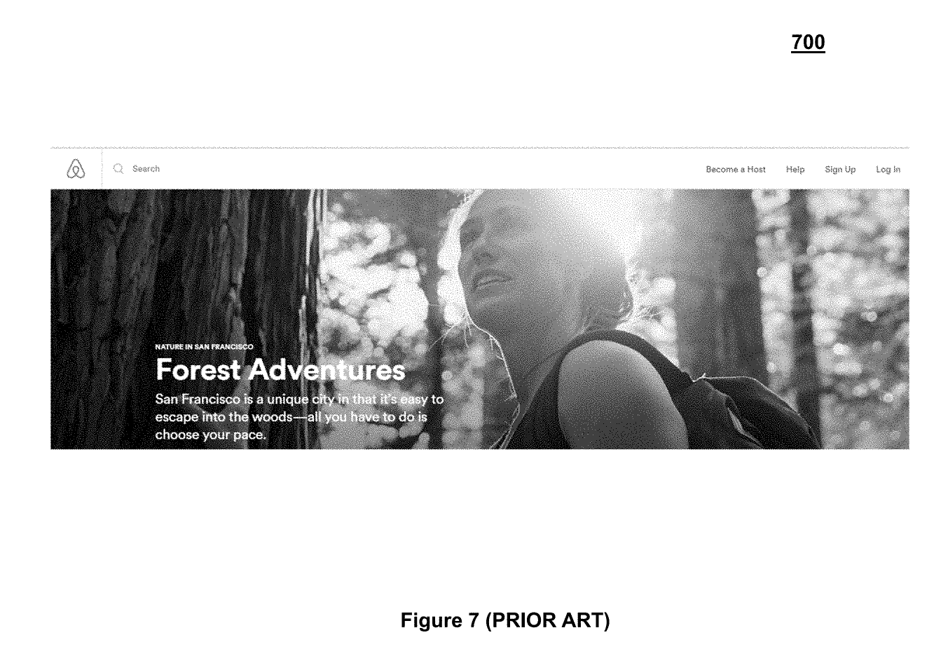

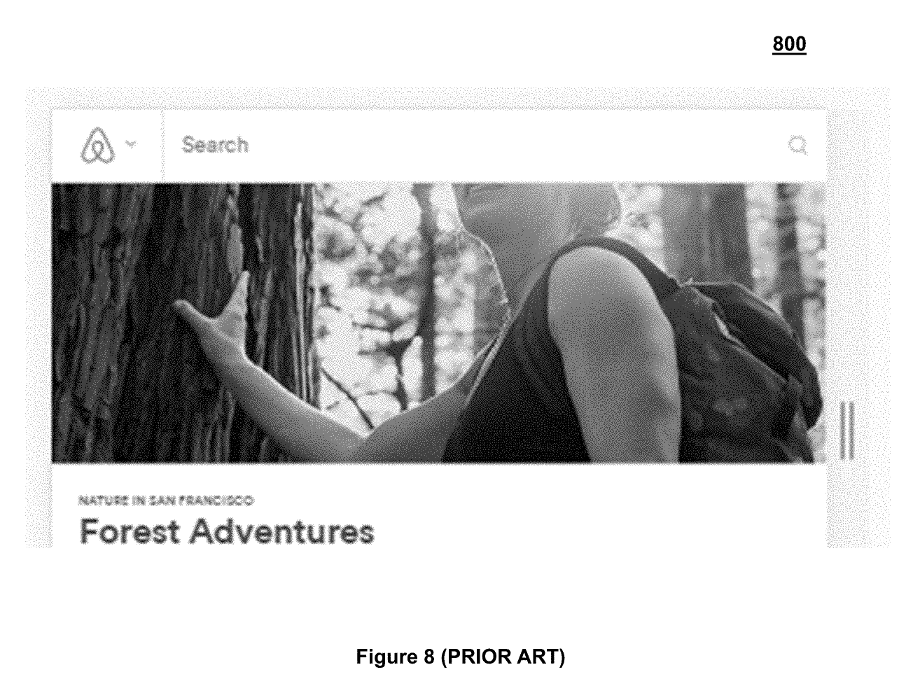

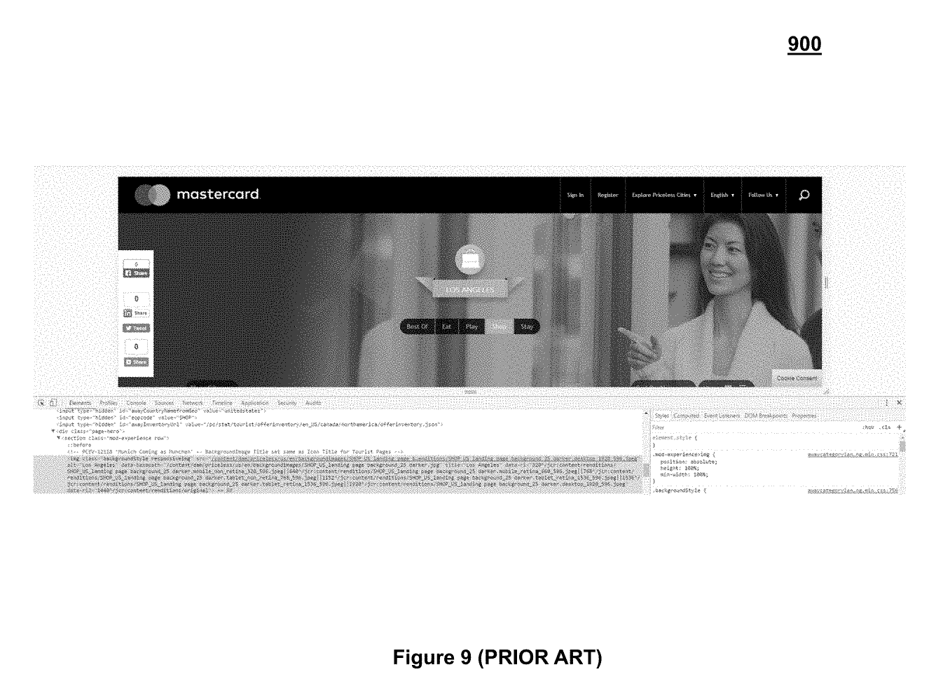

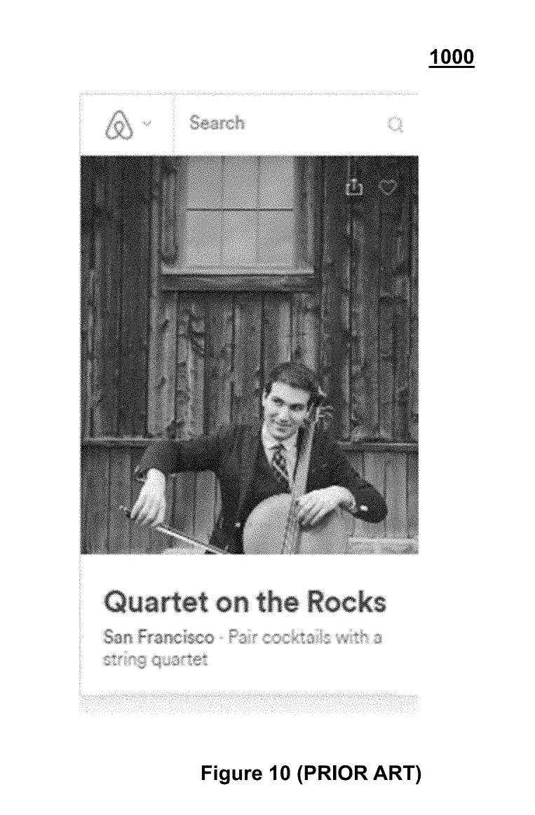

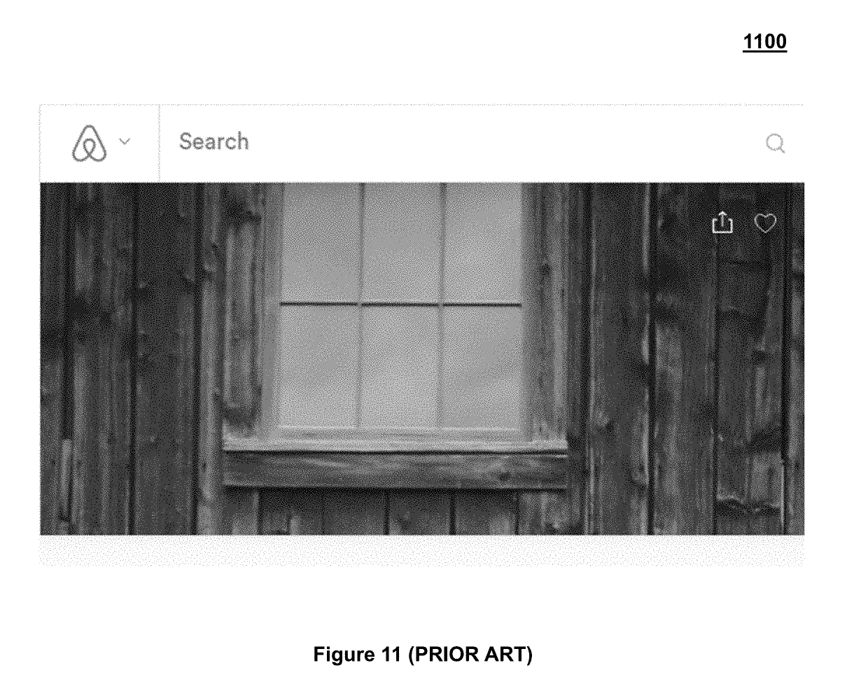

As can be seen from the example of FIGS. 2 to 10, different images have different features and should be rendered differently. In some images the subject of interest might be on the extreme left where as in other images the subject of interest might be on the extreme bottom of the source image, and a common rule of cropping or resizing the source image to render these images in different devices may not work efficiently. With the system shown in FIG. 1A and the method illustrated in FIG. 1B, this problem is resolved by using responsive styling. Media files (for example images or videos) may be provided in a contextual way to various device end points, and a digital image presentment framework may be provided, which may be used for digital brand sites.

The image presentment framework according to various embodiments may allow an author to define a presentment rule (in other words: a processing rule) which may be specific to an image. Appropriate device specific images may be presented on the fly, and may thus advantageously reduce the repository size and maintenance cost as only one pristine source image may need to be stored.

Advantageously, rules may be applied on the source image for specific devices, and as such, the resultant size of the image which is presented may be lower than the original size of the image. This may save bandwidth and network consumption.

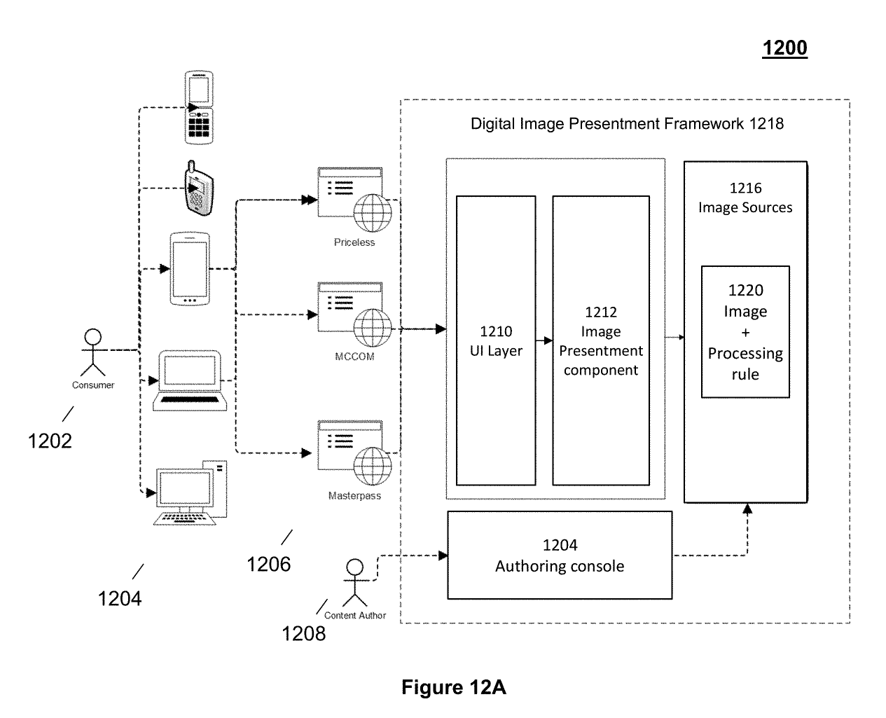

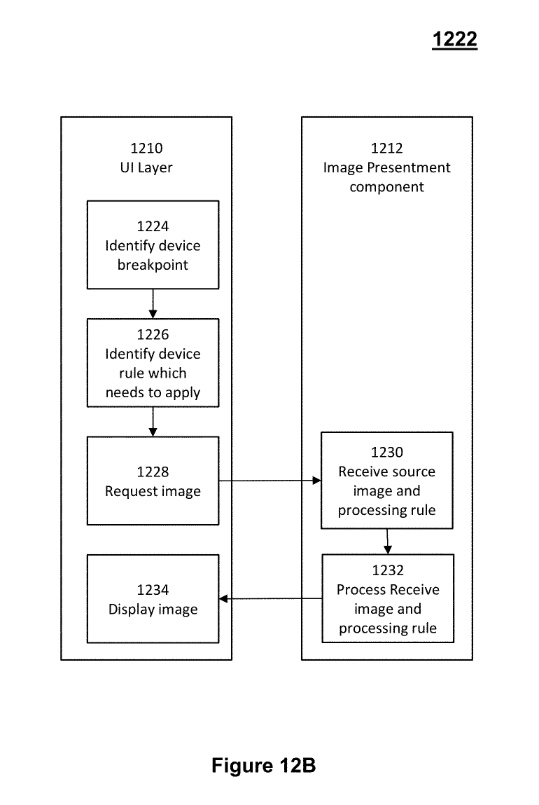

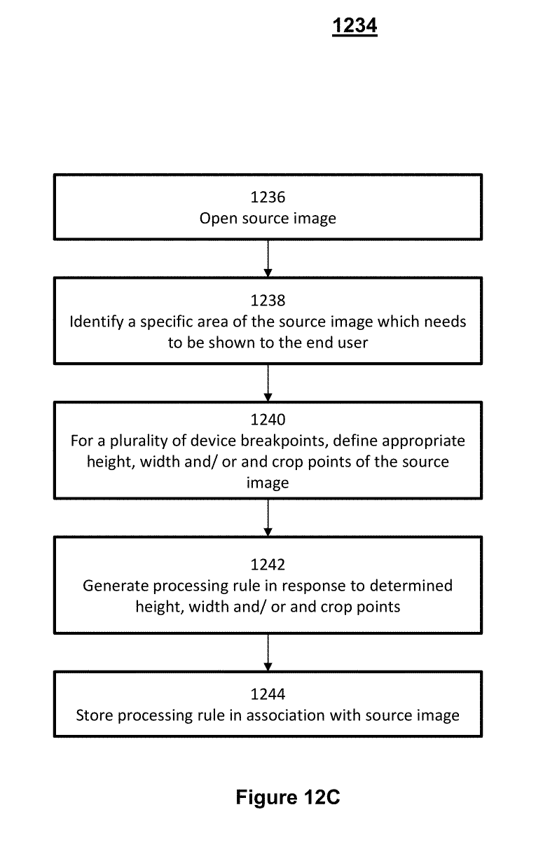

Advantageously, at the authoring side, there is provided a way to define a specific area of an image which needs to be shown to the end user based on the device. There are various device breakpoints which are defined and based on which portion of the image needs to be shown/focused, the appropriate height, width and crop points of the image may be calculated for example specifically for the image and based on properties of the display of the device, based on a source image (which may also be referred to as a pristine source image). A method of creating a processing rule (in other words: an authoring method) will be described in more detail below with reference to FIG. 12C.

According to various embodiments, images may be cropped differently for different viewpoints/device breakpoint. Furthermore, different presentment rules (like resizing the image, rotating the image, adjusting contrast/brightness, changing quality, adding greyscale etc.) may be added by adding simple configuration rules to the image.

Advantageously, processing may be carried out on a single image source, so that it may not be necessary to create multiple renditions/copies.

The rules may be executed (during run time) based on the device, which may allow flexibility to define a separate rule from image to image. An author may allow a digital website to show correct images in different viewpoints.

FIG. 12 shows a system diagram 1200 illustrating component interaction in accordance with an embodiment of the present disclosure. A user 1202 (for example a consumer, issuer, acquirer, merchant) may leverage a computer device 1204 (for example mobile device, a mobile phone, a laptop or a desktop computer) to access one of many digital web sites 1206. The digital image presentment framework 1218, which may for example be provided in the form of a image providing device, like image providing device 104 as shown in FIG. 1A, may obtain properties of the device 1204 which is accessing the site 1206 (for example properties of a display of the device, for example a size and resolution of the display). For example, the digital image presentment framework 1218 may receive a request for an image, and the request may include information on the property of the display of the device. In another example, the digital image presentment framework 1218 requests information on the property of the display of the device, and may receive the requested information in response. Then, the digital image presentment framework 1218 may render the image to the consumer using the appropriate rule defined for the device 1204. The images, when assembled, provide page content (for example according to HTML5 markup language) to the agent (for example web browser or application/app) of the computer device 1204. According to various embodiments, a single source image may be published with the meta-data rules and it may not be necessary to store multiple images variations in the repository for that image.

The image presentment framework 1218 which may for example be provided in the form of a image providing device, like image providing device 104 as shown in FIG. 1A, and which may for example be a web server hosting a website (or a web server hosting images for a website) according to various embodiments may include various modules as shown in FIG. 12 and as described below.

An authoring console 1214 is a console for a content author 1208 and provides for example a user interface for upload of an image, defining image presentment (or image processing) rules, and storing the rules as metadata. For example, a crop tool is provided which allows the author to select the start coordinates, height and width in a user friendly way. Input boxes may provide other options for input of further rules like resizing the image (which may maintain the aspect ratio of the image), rotating the image, adjusting contrast/brightness, changing quality, adding greyscale etc. The image processing rules are provided specific to devices, and separate tabs may be created in the authoring console 1204 for adding configurations specific to devices.

For example a copyright holder (for example the content author 1208) may use the authoring console 1204 to define how the source image shall be displayed on various displays, and may as such advantageously have control over how his images are displayed.

A data layer may be provided, for example with the image sources 1216, wherein a pristine source image 1220 (in other words: a source image) is added/fetched from a DAM (digital asset manager) or can be directly added under a content tree structure. This pristine source image may for example be uploaded to an image providing server of the digital image presentment framework 1218. Once the author finalizes different image configurations, the image data (including the processing rules) will be saved as metadata properties in a repository in the location where the pristine source image is stored.

A UI (user interface) layer 1210 and image presentment component 1212 are provided. The UI layer 1210 may determine the type of device (for example desktop, mobile, tablets, etc) on which the image is to be loaded, and in particular may determine properties of a display of the device. Once the device or display of the device is determined, the UI layer 1210 identifies a processing rule which needs to be applied, and requests the image on which the current device specific configuration is applied from the image presentment component 1212, which obtains the image and the rule from the image sources 1216. This request is sent with a configuration name which is specific to a device breakpoint.

The image presentment component 1212 reads the configurations/inputs and calculates a desired height, width, size of an image and provides, via the UI layer 1210, the final image to render on the browser based on the processing rule. The image presentment component 1212 may be a sling servlet on which the request is sent as described above, and it may read the configuration name sent in the request and use it to read configurations added by the author using the authoring console 1204. Once the servlet gets the configuration, it applies the presentment rule on the image and the new image rendition is created on the fly. This newly rendered image is sent as a response to the component on UI layer 1210.

CSS (cascading style sheet) rules may be used to maintain the aspect ratio of the image for odd breakpoints where normally a part of the image gets hidden. This may advantageously help to take care of unexpected crops happening in small devices for large images.

FIG. 12B shows a flow diagram 1222 illustrating the processing of the UI layer 1210 and the image presentment component 1212 as shown in FIG. 12A in accordance with an embodiment of the present disclosure. At 1224, the UI layer 1210 identifies a device breakpoint; this step corresponds to step 130 as illustrated in FIG. 1B above). At 1226, the UI layer 1210 identifies which rule needs to be applied; this step corresponds to step 132 as illustrated in FIG. 1B above. For requests for images to be displayed for which no specific rule is available (for example for a size that is in-between sizes for which rules are available), a rule that is provided for a size that is closest to the desired size may be applied, and then the image may be scaled to the desired size. At 1228, the UI layer requests the (source) image, from the image presentment component 1212 (for example via an URL (uniform resource locator; in other words: a web address) wherein the URL of the image presentment component 1212 is appended by a specific URL for the image and/or the rule), and at 1230, the image presentment component receives the source image (for example from the image sources 1216 as shown in FIG. 12A); these steps corresponds to step 128 as illustrated in FIG. 1B above. At 1232, the image presentment component 1212 takes the source image and applies the rule to the source image; this step corresponds to step 134 as illustrated in FIG. 1B above). Then the image presentment component 1212 provides the processed image to be displayed to the UI layer 1212 for display at 1234; this step corresponds to step 136 as shown in FIG. 1B above.

FIG. 12C shows a flow diagram 1234 illustrating an authorizing method in accordance with an embodiment of the present disclosure, for example using the authoring console 1204. At 1236, the content author 1208 opens a source image. At 1238, for example based on visual inspection of the source image, the content author 1238 identifies a specific area of the source image which needs to be shown to the end user.

It will be understood that instead of the content author 1208 opening the source image at 1236 for visual inspection and the content author 1208 manually identifying the specific areas, the specific areas may be automatically determined by the authoring console, for example based on image analysis techniques, like for example image segmenting the image.

Based on the defined specific area (no matter whether manually determined by the content author 1208, or automatically determined by the authoring console 1204), the authoring console 1204, for a plurality of device breakpoints (which may for example relate to the devices shown in FIG. 1A, for example a mobile phone 106 in portrait mode, a mobile phone 108 in landscape mode, a tablet device 110, and a personal computer 112), defines appropriate heights, widths and/or and crop points of the source image. In response to the determined appropriate heights, widths and/or and crop points, a processing rule for each of the device breakpoints is generated at 1242, and at 1244, the processing rule is stored in association with the source image (for example as metadata of the source image, or as separate data linked to the source image).

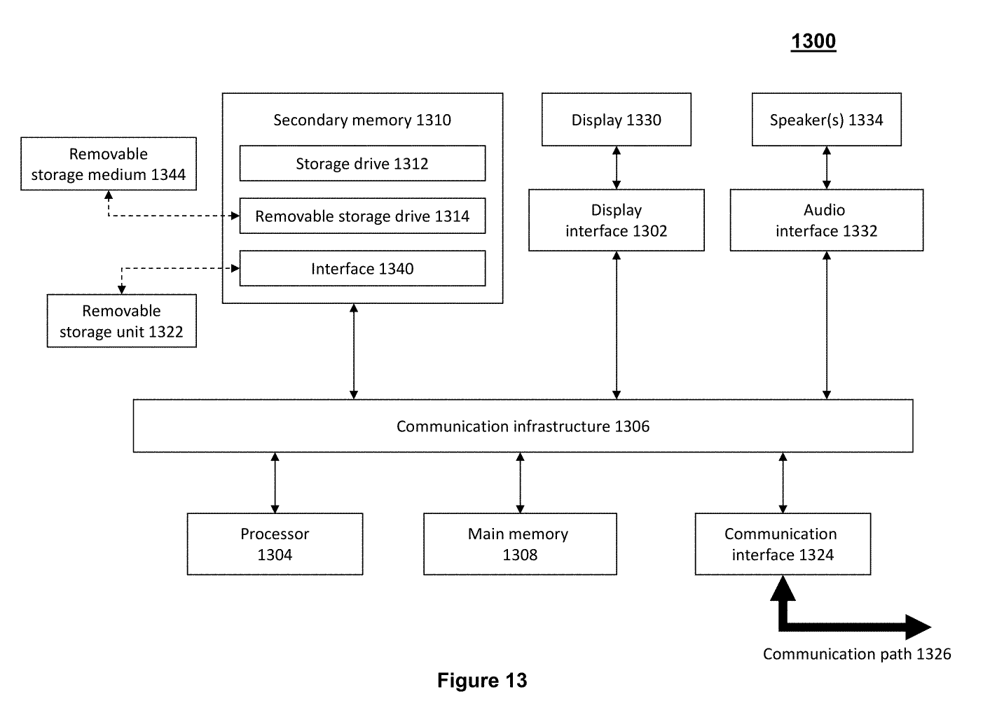

FIG. 13 depicts an exemplary computing device 1300, herein interchangeably referred to as a computer system 1300 or as a server 1300, where one or more such computing devices 1300 may be used to implement the image providing device 104 shown in FIG. 1A. The following description of the computing device 1300 is provided by way of example only and is not intended to be limiting.

As shown in FIG. 13, the example computing device 1300 includes a processor 1304 for executing software routines. Although a single processor is shown for the sake of clarity, the computing device 1300 may also include a multi-processor system. The processor 1304 is connected to a communication infrastructure 1306 for communication with other components of the computing device 1300. The communication infrastructure 1306 may include, for example, a communications bus, cross-bar, or network.

The computing device 1300 further includes a main memory 1308, such as a random access memory (RAM), and a secondary memory 1310. The secondary memory 1310 may include, for example, a storage drive 1312, which may be a hard disk drive, a solid state drive or a hybrid drive and/or a removable storage drive 1314, which may include a magnetic tape drive, an optical disk drive, a solid state storage drive (such as a USB flash drive, a flash memory device, a solid state drive or a memory card), or the like. The removable storage drive 1314 reads from and/or writes to a removable storage medium 1344 in a well-known manner. The removable storage medium 1344 may include magnetic tape, optical disk, non-volatile memory storage medium, or the like, which is read by and written to by removable storage drive 1314. As will be appreciated by persons skilled in the relevant art(s), the removable storage medium 1344 includes a computer readable storage medium having stored therein computer executable program code instructions and/or data.

In an alternative implementation, the secondary memory 1310 may additionally or alternatively include other similar means for allowing computer programs or other instructions to be loaded into the computing device 1300. Such means can include, for example, a removable storage unit 1322 and an interface 1350. Examples of a removable storage unit 1322 and interface 1350 include a program cartridge and cartridge interface (such as that found in video game console devices), a removable memory chip (such as an EPROM or PROM) and associated socket, a removable solid state storage drive (such as a USB flash drive, a flash memory device, a solid state drive or a memory card), and other removable storage units 1322 and interfaces 1350 which allow software and data to be transferred from the removable storage unit 1322 to the computer system 1300.

The computing device 1300 also includes at least one communication interface 1324 (in other words: a communication port). The communication interface 1324 allows software and data to be transferred between computing device 1300 and external devices via a communication path 1326. In various embodiments of the inventions, the communication interface 1324 permits data to be transferred between the computing device 1300 and a data communication network, such as a public data or private data communication network. The communication interface 1324 may be used to exchange data between different computing devices 1300 which such computing devices 1300 form part an interconnected computer network. Examples of a communication interface 1324 can include a modem, a network interface (such as an Ethernet card), a communication port (such as a serial, parallel, printer, GPIB, IEEE 1394, RJ45, USB), an antenna with associated circuitry and the like. The communication interface 1324 may be wired or may be wireless. Software and data transferred via the communication interface 1324 are in the form of signals which can be electronic, electromagnetic, optical or other signals capable of being received by communication interface 1324. These signals are provided to the communication interface via the communication path 1326.

As shown in FIG. 13, the computing device 1300 further includes a display interface 1302 which performs operations for rendering images to an associated display 1330 and an audio interface 1332 for performing operations for playing audio content via associated speaker(s) 1334.

As used herein, the term “computer program product” (or computer readable medium, which may be a non-transitory computer readable medium) may refer, in part, to removable storage medium 1344, removable storage unit 1322, a hard disk installed in storage drive 1312, or a carrier wave carrying software over communication path 1326 (wireless link or cable) to communication interface 1324. Computer readable storage media (or computer readable media) refers to any non-transitory, non-volatile tangible storage medium that provides recorded instructions and/or data to the computing device 1300 for execution and/or processing. Examples of such storage media include magnetic tape, CD-ROM, DVD, Blu-ray™ Disc, a hard disk drive, a ROM or integrated circuit, a solid state storage drive (such as a USB flash drive, a flash memory device, a solid state drive or a memory card), a hybrid drive, a magneto-optical disk, or a computer readable card such as a PCMCIA card and the like, whether or not such devices are internal or external of the computing device 1300. Examples of transitory or non-tangible computer readable transmission media that may also participate in the provision of software, application programs, instructions and/or data to the computing device 1300 include radio or infra-red transmission channels as well as a network connection to another computer or networked device, and the Internet or Intranets including e-mail transmissions and information recorded on Websites and the like.

The computer programs (also called computer program code) are stored in main memory 1308 and/or secondary memory 1310. Computer programs can also be received via the communication interface 1324. Such computer programs, when executed, enable the computing device 1300 to perform one or more features of embodiments discussed herein. In various embodiments, the computer programs, when executed, enable the processor 1304 to perform features of the above-described embodiments. Accordingly, such computer programs represent controllers of the computer system 1300.

Software may be stored in a computer program product and loaded into the computing device 1300 using the removable storage drive 1314, the storage drive 1312, or the interface 1350. The computer program product may be a non-transitory computer readable medium. Alternatively, the computer program product may be downloaded to the computer system 1300 over the communications path 1326. The software, when executed by the processor 1304, causes the computing device 1300 to perform functions of embodiments described herein.

It is to be understood that the embodiment of FIG. 13 is presented merely by way of example. Therefore, in some embodiments one or more features of the computing device 1300 may be omitted. Also, in some embodiments, one or more features of the computing device 1300 may be combined together. Additionally, in some embodiments, one or more features of the computing device 1300 may be split into one or more component parts. The main memory 1308 and/or the secondary memory 1310 may serve(s) as the memory for the image providing device 104 shown in FIG. 1A; while the processor 1304 may serve as the processor of the image providing device 104 shown in FIG. 1A.

Some portions of the description herein are explicitly or implicitly presented in terms of algorithms and functional or symbolic representations of operations on data within a computer memory. These algorithmic descriptions and functional or symbolic representations are the means used by those skilled in the data processing arts to convey most effectively the substance of their work to others skilled in the art. An algorithm is here, and generally, conceived to be a self-consistent sequence of steps leading to a desired result. The steps are those requiring physical manipulations of physical quantities, such as electrical, magnetic or optical signals capable of being stored, transferred, combined, compared, and otherwise manipulated.

Unless specifically stated otherwise, and as apparent from the description herein, it will be appreciated that throughout the present specification, discussions utilizing terms such as “receiving”, “scanning”, “capturing”, “calculating”, “determining”, “replacing”, “generating”, “initializing”, “outputting”, or the like, refer to the action and processes of a computer system, or similar electronic device, that manipulates and transforms data represented as physical quantities within the computer system into other data similarly represented as physical quantities within the computer system or other information storage, transmission or display devices.

The present specification also discloses apparatus for performing the operations of the methods. Such apparatus may be specially constructed for the required purposes, or may comprise a computer or other device selectively activated or reconfigured by a computer program stored in the computer. The algorithms and displays presented herein are not inherently related to any particular computer or other apparatus. Various machines may be used with programs in accordance with the teachings herein. Alternatively, the construction of more specialized apparatus to perform the required method steps may be appropriate. The structure of a computer suitable for executing the various methods/processes described herein will appear from the description herein.

In addition, the present specification also implicitly discloses a computer program, in that it would be apparent to the person skilled in the art that the individual steps of the method described herein may be put into effect by computer code. The computer program is not intended to be limited to any particular programming language and implementation thereof. It will be appreciated that a variety of programming languages and coding thereof may be used to implement the teachings of the disclosure contained herein. Moreover, the computer program is not intended to be limited to any particular control flow. There are many other variants of the computer program, which can use different control flows without departing from the spirit or scope of the invention.

Furthermore, one or more of the steps of the computer program may be performed in parallel rather than sequentially. Such a computer program may be stored on any computer readable medium. The computer readable medium may include storage devices such as magnetic or optical disks, memory chips, or other storage devices suitable for interfacing with a computer. The computer readable medium may also include a hard-wired medium such as exemplified in the Internet system, or wireless medium such as exemplified in the GSM mobile telephone system. The computer program when loaded and executed on such a computer effectively results in an apparatus that implements the steps of the preferred method.

According to various embodiments, a “circuit” may be understood as any kind of a logic implementing entity, which may be special purpose circuitry or a processor executing software stored in a memory, firmware, or any combination thereof. Thus, in an embodiment, a “circuit” may be a hard-wired logic circuit or a programmable logic circuit such as a programmable processor, e.g. a microprocessor (e.g. a Complex Instruction Set Computer (CISC) processor or a Reduced Instruction Set Computer (RISC) processor). A “circuit” may also be a processor executing software, e.g. any kind of computer program, e.g. a computer program using a virtual machine code such as e.g. Java. Any other kind of implementation of the respective functions which will be described in more detail below may also be understood as a “circuit” in accordance with an alternative embodiment.

It will be understood that functionality of one or more circuits may be combined in a single circuit or split up into several circuits.

Various features are described for a device, but may analogously also be provided for a method, and vice versa.

In accordance with an embodiment of the present disclosure, a method for dynamically displaying a cropped image is provided. The method includes: receiving an original image; determining a target size of an image to be displayed; determining a cropping rule based on the original image and based on a target size, wherein the cropping rule comprises a starting point of cropping; and cropping the original image to obtain the cropped image to be displayed based on the cropping rule.

Thus, it can be seen that devices and methods have been provided to overcome the problems of unsuitable processing of images for different devices, where important information is lost, for example by providing a method for dynamically providing an image to be displayed on a display of a device, and an image providing device. Such a method includes: receiving a source image; receiving a property of the display of the device on which the image is to be displayed; determining a processing rule based on the source image; processing the source image based on the processing rule and based on the property of the display of the device to obtain the image to be displayed; and providing the image to be displayed to the device. Such an image providing device includes: at least one processor; at least one memory including computer program code; and the at least one memory and the computer program code configured to, with the at least one processor, cause the at least one processor to: receive a source image; receive a property of a display of a target device on which the image is to be displayed; determine a processing rule based on the source image; process the source image based on the processing rule and based on the property of the display of the target device to obtain the image to be displayed; and provide the image to be displayed to the target device.

In the method, a property of the display of the device on which the image is to be displayed is received. This may advantageously allow adjusting the source image specifically for the display.

A processing rule is determined based on the source image. This may advantageously allow formalizing adjustments that are to be made to the source image for generating the image to be displayed, which may simplify processing.

The processing rule may be determined based on metadata of the source image, which may advantageously simplify storage of the processing rule.

The processing rule may include a rule related to cropping of the source image, and/or a rule related to resizing of the source image, and/or a rule related to recoloring of the source image and/or a rule related to any other kind of processing of the source image. This may advantageously allow ample modifications to be made to the source image before it is displayed in a processed form.

Determining the processing rule may include determining a starting point for the cropping of the source image. This may advantageously allow cropping the source image around an important area of the source image.

Processing the source image may include determining a size for the re-sizing of the source image based on the property of the display of the device. This may advantageously allow providing the image to be displayed in a suitable size.

Processing the source image may include determining parameters for the recoloring of the source image based on the property of the display of the device. This may advantageously allow compensation for different color representations among displays.

It will be appreciated by a person skilled in the art that numerous variations and/or modifications may be made to the present invention as shown in the specific embodiments without departing from the spirit or scope of the invention as broadly described. The present embodiments are, therefore, to be considered in all respects to be illustrative and not restrictive.

1. A method for dynamically providing an image to be displayed on a display of a device, the method comprising:
receiving a source image;
receiving a property of the display of the device on which the image is to be displayed;
determining a processing rule based on the source image;
processing the source image based on the processing rule and based on the property of the display of the device to obtain the image to be displayed; and
providing the image to be displayed to the device.

2. The method of claim 1,
wherein the processing rule is determined further based on metadata of the source image.

3. The method of claim 1,
wherein the source image is a still image or a moving image.

4. The method of claim 1,
wherein the processing rule comprises a rule related to cropping of the source image.

5. The method of claim 4,
wherein determining the processing rule comprises determining a starting point for the cropping of the source image.

6. The method of claim 1,
wherein the processing rule comprises a rule related to resizing of the source image.

7. The method of claim 6,
wherein processing the source image comprises determining a size for the re-sizing of the source image based on the property of the display of the device.

8. The method of claim 1,
wherein the processing rule comprises a rule related to recoloring of the source image.

9. The method of claim 8,
wherein processing the source image comprises determining parameters for the recoloring of the source image based on the property of the display of the device.

10. An image providing device comprising:
at least one processor;
at least one memory including computer program code; and
the at least one memory and the computer program code configured to, with the at least one processor, cause the at least one processor to:
receive a source image;
receive a property of a display of a target device on which the image is to be displayed;
determine a processing rule based on the source image;
process the source image based on the processing rule and based on the property of the display of the target device to obtain the image to be displayed; and
provide the image to be displayed to the target device.

11. The image providing device of claim 10,
wherein the at least one memory and the computer program code are further configured to, with the at least one processor, cause the at least one processor to determine the processing rule further based on metadata of the source image.

12. The image providing device of claim 10,
wherein the source image is a still image or a moving image.

13. The image providing device of claim 10,
wherein the processing rule comprises a rule related to cropping of the source image.

14. The image providing device of claim 13,
wherein determining the processing rule comprises determining a starting point for the cropping of the source image.

15. The image providing device of claim 10,
wherein the processing rule comprises a rule related to resizing of the source image.

16. The image providing device of claim 15,
wherein processing the source image comprises determining a size for the re-sizing of the source image based on the property of the display of the target device.

17. The image providing device of claim 10,
wherein the processing rule comprises a rule related to recoloring of the source image.

18. The image providing device of claim 17,
wherein processing the source image comprises determining parameters for the recoloring of the source image based on the property of the display of the target device.

19. The image providing device of claim 10,
wherein the image providing device is a server or is configured to be coupled to a server or is the target device.

20. A method for dynamically displaying a cropped image, the method comprising:
receiving an original image;
determining a target size of an image to be displayed;
determining a cropping rule based on the original image and based on a target size, wherein the cropping rule comprises a starting point of cropping; and
cropping the original image to obtain the cropped image to be displayed based on the cropping rule.
